(19) United States
(12) Patent Application Publication
(10) Pub. No.: US 2012/0040258 A1
(43) Pub. Date: Feb. 16, 2012

(54) Fuel Cell System Comprising at Least One Fuel Cell

(75) Inventors: Gerhard Konrad, Ulm (DE); Felix Sterk, Schlier (DE)

(73) Assignee: Daimler AG, Stuttgart (DE)

(21) Appl. No.: 13/202,138

(22) PCT Filed: Jan. 27, 2010
(86) PCT No.: PCT/EP2010/000469

§ 371 Date: Nov. 2, 2011

(30) Foreign Application Priority Data
Feb. 19, 2009 (DE) 10 2009 009 673.6

(51) Int. Cl. H01M 8/06

(52) U.S. Cl. 429/414

(57) ABSTRACT

A fuel cell system includes a fuel cell with cathode and anode regions. The fuel cell system also includes an exchanging device through which an intake air flow flows to the cathode region and a used air flow is discharged from the cathode region. In the exchanging device, heat is transferred from the intake air flow to the used air flow, and water vapor is simultaneously transferred from the used air flow to the intake air flow. A compressor is arranged downstream of the exchanging device to receive used air. A catalytic material is arranged upstream of the turbine, to which material can be supplied a fuel-containing gas. The catalytic material is integrated into the exchanging device on the used air side and an exhaust gas from the anode region is supplied to the used air side of the exchanging device.

### BACKGROUND AND SUMMARY OF THE INVENTION

The invention relates to a fuel cell system comprising at least one fuel cell.

A generic fuel cell system is described in German patent document DE 10 2007 003 144 A1. The fuel system comprises an exchange device, which combines the two functions “cooling” and humidification”. The exchanging device, which is referred to as a function unit in that document, permits a material flow from the exhaust air of the fuel cell to the intake air to the fuel cell, while a heat exchange occurs from the intake air heated by a compression device to the comparatively cool exhaust air. The construction of DE 10 2007 003 144 A1 additionally shows a construction, where the air supply of the fuel cell system is realized via a compressor, which can be driven by a turbine and/or an electric motor. This generally known construction with fuel cell systems is also called an electric turbocharger and permits the at least supporting drive of the compressor, and, with a power excess of the electrical machine as a generator, through the turbine.

Additionally, a fuel cell system with an anode recirculation cycle is disclosed in U.S. Patent Application Publication No. US2005/0019633 A1. With this system, the exhaust gas discharged from time to time from the anode cycle is mixed with exhaust gas from the region of the cathode, which is generally used air, as and is combusted in a catalytic combustor. With the catalytic combustion of the dehumidified used air and the exhaust gas from the anode region, a corresponding heat amount results, which can be used to heat the cooling cycle of the fuel cell system.

This operating guidance represents a corresponding advantage for the cold start of such a fuel cell system, for the regular operation it is, however, very critical to supply this exhaust heat to the cooling water, as the cooling surface available, for example with a use in a vehicle, is rather not or only hardly sufficient to cool the fuel cell sufficiently. Additionally, the exhaust heat resulting in the region of the catalytic burner is not used actively with the construction of US 2005/0019633 A1, apart for the cold start case.

Accordingly, the present invention improves a fuel cell system in such a manner that no hydrogen emissions reach the environment, and that the fuel cell system is operated with a best possible use of the available energy.

By means of the integration of the catalytic material into the used air side of the exchanging device, an additional component is saved and the line guidance for the exhaust gas from the anode region is shortened. This construction enables the exhaust gas flow directly into the used air behind the cathode region, as this mixture of the gases then reaches the exchanging device together, in which the residual hydrogen present in the exhaust gas can react with residual oxygen in the used air of the cathode region in the region of the catalytic material. Heat and water vapor result from this reaction. The heat is particularly helpful here, as it introduces additional heat into the used air in addition to the heat introduction by the very hot intake air behind the compressor, which flows from the exchanging device in the direction of the turbine.

The construction of the fuel cell system according to the invention thus permits conversion of hydrogen-containing exhaust gas from the anode region together with residual oxygen in the used air from the cathode region and thus prevents an emission of hydrogen to the environment of the fuel cell system. Additionally, the used air will be clearly hotter behind the exchanging device by means of the resulting exhaust heat, as without the catalytic material in the used air side of the exchanging device. This allows additional energy to be supplied to the turbine. The energy resulting from the conversion of the hydrogen-containing exhaust gas can thus be used beneficially in the fuel cell system, in that it supports the drive of the turbine.

According to a particularly favorable arrangement of the fuel cell system, an additional fuel, particularly hydrogen, can be supplied as fuel-containing gas.

This arrangement permits an additional fuel to be supplied as fuel-containing gas in addition to the exhaust gas from the anode region. This fuel could, in principle, be an arbitrary fuel. If the fuel cell system is, however, operated with hydrogen, and this hydrogen is present in any case, this hydrogen can be used as additional fuel in an ideal manner. The supply of the additional fuel to the exchanging device, and thus to the catalytic material in the used air side of the exchanging device, leads to an increased conversion of fuel with the residual oxygen in the used air. This generates additional heat, which then clearly increases the power that can be recalled via the turbine. This additional energy can then be used for the drive of the compressor.

According to a particularly favorable arrangement of the invention, the compressor can be driven by an electrical machine, wherein the turbine drives the electrical machine in a generator manner for generating electrical energy with a power excess at the turbine.

If additional fuel is now introduced into the region of the catalytic material on the used air side of the exchanging device with this arrangement of the fuel cell system with an electrical machine in the above-mentioned type, electrical energy can also be generated directly by the additionally resulting heat, which can then be used as additional electrical energy not only for driving the compressor, but also for further electrical users, as for example electric motors or the like. A “boost” operation can thus be realized via the additional generation of exhaust heat.

In a particularly advantageous arrangement of the invention, the region with the catalytic material is shielded thermally compared to the intake air side of the exchanging device.

This can, for example, take place such that the two regions are not in any or only an indirect thermal contact to each other, for example such that a material conducting heat comparatively poorly or an air gap is realized between the intake air side and the used air side of the exchanging device in this region. It can thereby avoid the exhaust heat resulting in the region of the catalytic material, and here particularly the heat resulting during the operation with additional fuel, heats the intake air to the cathode region of the fuel cell in an unnecessary manner.

The fuel cell system according to the invention in all its disclosed versions thus permits a simple, compact and thus also cost-efficient construction with an arrangement ideal for the life span and the efficiency that can be achieved. The fuel cell system according to the invention is thus particularly suitable for the use in a means of transport, and here for the generation of power for the drive and/or electrical auxiliary users in the means of transport. A means of transport in the sense of the present invention is meant to be any type of means of transport on land, on water or in the air, wherein a particular attention is certainly in the use of these fuel cell systems for motor vehicle with no rails, without the use of a fuel cell system according to the invention being restricted hereby.

Further advantageous arrangements of the fuel cell system will become clear by means of the exemplary embodiments, which are described in more detail in the following with reference to the figures.

### BRIEF DESCRIPTION OF THE DRAWING FIGURES

It shows thereby:

FIG. 1 a first possible embodiment of the fuel cell system according to the invention; and

FIG. 2 a further alternative embodiment of the fuel cell system according to the invention.

### DETAILED DESCRIPTION

The depiction in the following figures shows only the components necessary for the understanding of the present invention in a highly schematized depiction of the very complex fuel cell system per se. It should thereby be understood for the fuel cell system that further components, as for example a cooling cycle and the like are also provided in the fuel cell system, even though these are not considered in the figures shown in the following.

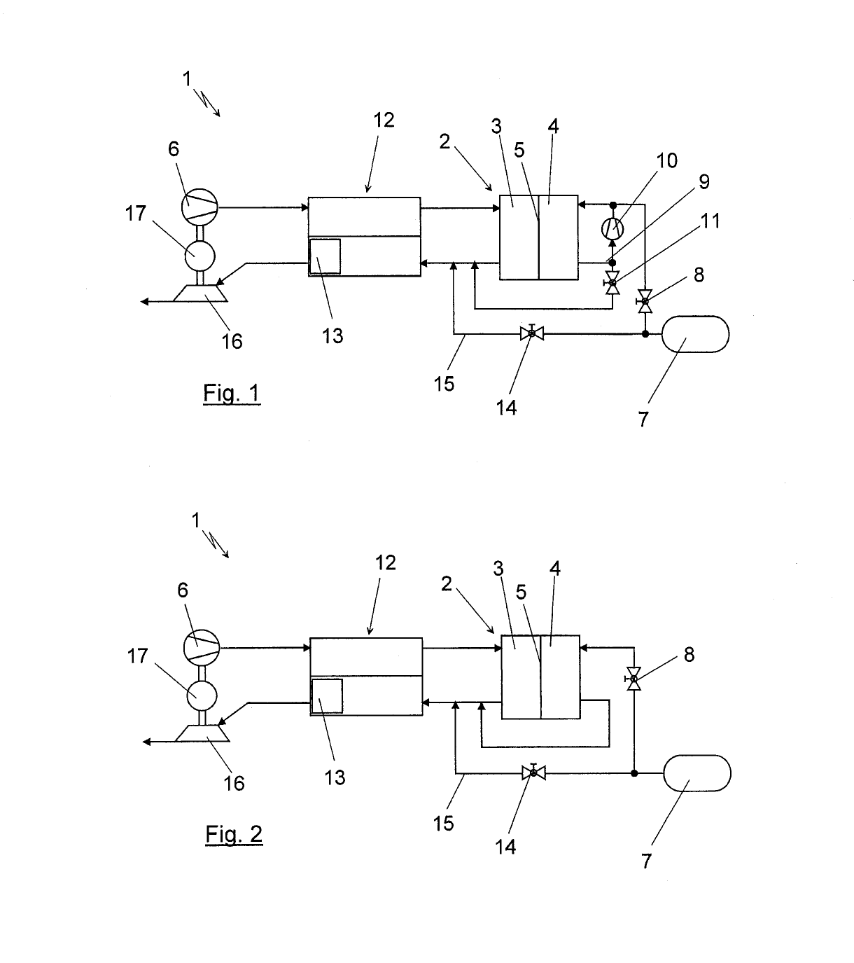

FIG. 1 shows a fuel cell system 1 comprising a fuel cell 2. The fuel cell 2 includes a fuel cell 2 constructed of a stack of individual cells in a usual manner. A cathode region 3 and an anode region 4 is formed in the fuel cell 2, which regions are separated from each other by a PE membrane 5 in the exemplary embodiment shown here. In the exemplary embodiment shown in FIG. 1, an intake air flow is supplied to the cathode region 3 via a compressor 6. The compressor 6 can thereby, for example, be designed as a screw compressor or as a flow compressor, as is customary with fuel cell systems. Basically, other possibilities for compressing the supplied air flow are, however, also conceivable, for example by a piston machine or the like. The intake air flow supplied to the cathode region 3 reacts to water with the hydrogen supplied to the anode region 4 in the fuel cell 2, whereby electrical power is released. This principle of the fuel cell 2 known per se only has a subordinate role for the present invention, this is why it shall not be explained in more detail.

Hydrogen from a hydrogen storage device 7, for example, a pressure store and/or a hydride store, is supplied to the anode region 4 in the exemplary embodiment shown here. It would also be conceivable to supply the fuel cell 2 with a hydrogen-containing gas, which is, for example, generated from hydrocarbon-containing start materials in the region of the fuel cell system.

In the exemplary embodiment of FIG. 1, the hydrogen from the hydrogen storage device 7 is guided into the anode region 4 via a dosing device 8, schematically illustrated in the figure. The exhaust gas flowing from the anode region, which gas generally still contains a comparatively high amount of hydrogen, is fed back into the anode region 4 via a recirculation line 9 and a recirculation feed device 10. In the region of this recirculation, fresh hydrogen discharged from the hydrogen storage device 7 is thereby supplied, so that a sufficient amount of hydrogen is always available in the anode region 4. The construction of the anode region 4 of the fuel cell 2 with the recirculation line 9 and the recirculation feed device 10 is known per se and customary. A gas jet pump can, for example, be used as recirculation feed device 10, which pump is driven by the fresh hydrogen discharged from the hydrogen storage device 7. A recirculation blower would alternatively also be conceivable as recirculation feed device 10. Combinations of these different feed devices are naturally also possible, which shall also be included in the definition of the recirculation feed device 10 according to the present description. It is additionally known with the use of a recirculation of anode exhaust gas, that inert gases, for example nitrogen, accumulate over time in the region of the recirculation line 9, which reach from the cathode region 3 to the anode region 4 through the PE membrane 5. In order to be able to further provide a sufficient amount of hydrogen in the anode region, it is thus necessary to discharge the exhaust gas of the anode region 4 in the recirculation line 9. For this, a discharge valve 11 is provided in the exemplary embodiment according to FIG. 1, through which valve the exhaust gas from the anode region 4 can be discharged from time to time. This process is often also called “purge”. The exhaust gas thereby always also contains a corresponding amount of residual hydrogen in addition to the inert gases.

The intake air flowing from the compressor 6 to the cathode region 3 flows through an exchanging device 12 in the construction of the fuel cell system 1 according to FIG. 1, in which exchanging device the conditioning of the intake air occurs. The intake air will typically have a comparatively high temperature behind the compressor 6. As the fuel cell 2, and here particularly the PE membranes 5 of the fuel cell 2, react sensitively to a temperature that is too high and to gases which are too dry, the intake air in the exchanging device 12 is cooled and humidified correspondingly. For the cooling and the humidifying, the used air flow coming from the cathode region 3 is used. This also flows through the exchanging device 12. The exchanging device 12 is constructed in such a manner that it basically separates the two material flows of the intake air and the used air. This can, for example, take place in that one of the material flows flows through hollow fibers, while the other one of the material flows flows around the hollow fibers. It would additionally be conceivable to construct the exchanging device 12 in the manner of a plate reactor, where the two material flows are separated from each other by planar plates or membranes.

It has proved to be particularly advantageous to construct the exchanging device 12 in the form of a honeycomb body, as is, for example, customary with exhaust gas catalysts of motor vehicles. A corresponding arrangement of the honeycomb body can result in the intake air flow and the used air flow flow in different adjacent channels of the honeycomb body. Any type of flow-through is thus basically conceivable, for example, a co-current flow guidance or a cross flow guidance of the two material flows. It has, however, shown to be particularly suitable to guide the material flows through the exchanging device 12 in a counterflow or a flow guide with a high counterflow part. A heat exchange of the hot intake air flow to the cold used air flow of the cathode region 13 results now in the exchanging device 12. A counterflow guidance results in the coldest used air flow being in heat-conductive contact with the part of the intake air flow that is already cooled the most, while the used air flow that is already heated to a large extent cools the intake air flow which is still very hot during the inflow into the exchanging device 12. A very good cooling of the intake air flow is thereby achieved. The material of the exchanging device, for example, temperature-resistant membranes, porous ceramics, zeolites or the like, permits a passage of water vapor from the very humid used air flow of the cathode region 3, which entrains the product water resulting in the fuel cell 2, into the region of the very dry intake air flow to the cathode region 3. The intake air flow is humidified correspondingly thereby, which has a positive effect on the function and the life span of the PE membranes 5 in the region of the fuel cell 2. The construction and the function of the exchanging device 12 also already known from DE 10 2007 003 144 A1 already mentioned above.

In the exemplary embodiment present here, the exchanging device 12 has a catalytic material in addition to its construction according to the state of the art. This catalytic material, which shall be symbolized in the depiction by the region 13, serves for the reaction of hydrogen with the oxygen in the intake air. The hydrogen thereby comes from the recirculation line 9 around the anode region 2 of the fuel cell 2. It is, as already mentioned, discharged from time to time via the discharge valve 11. This hydrogen-containing exhaust gas, which is also called purge gas, now reaches the exchanging device 12 on the used air side. The exhaust gas or the hydrogen contained in the exhaust gas can react there with a part of the residual oxygen in the used air in the region of catalytic material 13. Heat and water in the form of water vapor result.

Additionally, a further fuel can be supplied to the exchanging device 12 on the used air side. This could be the hydrogen already present in the fuel cell system 1. It is, however, also conceivable to supply a hydrocarbon or the like, if this would be available in the fuel cell system 1. The supply of the additional hydrogen takes place in the exemplary embodiment of the fuel cell system 1 shown here from the region of the water storage device 7 via a dosing device 14 and a corresponding guidance element 15. The optional hydrogen can, as also the exhaust gas from the anode region 4, be introduced either into the feed line of the used air in front of exchanging device 12, as is indicated in principle by FIG. 1. Alternatively, it would also be conceivable to introduce the exhaust gas and/or the hydrogen directly into the exchanging device 12, and here particularly in the region of the catalytic material 13. The additional hydrogen can now be used to generate additional heat in the region of the catalytic material 13. In order to restrict the entry of the generated heat from the region of the catalytic material 13 into the intake air to the cathode region 3, a thermal decoupling can be arranged between the used air region and the intake air region of the exchanging device 12. Such a thermal decoupling can, for example, be realized by an air gap or a material that conducts heat poorly. It would also be conceivable that the region with the catalytic material 13 projects from the exchanging device 12 compared to the intake air region, so that the intake air flowing into the exchanging device 12 does not experience any direct contact with the region of the catalytic material 13 on the used air side.

The fuel cell system 1 now additionally has the possibility to use the exhaust heat present in the used air and the pressure energy contained therein. For this, the used air flows through a turbine 16 after the exchanging device 12, in which turbine the exhaust heat contained therein converts to mechanical energy. The turbine 16 is thereby coupled directly or indirectly to the compressor 6, so that energy occurring in the turbine 16 can be used for operating the compressor 6. As the energy supplied via the turbine 16 will not be sufficient in most of the operating states to operate the compressor 6, it is additionally coupled to an electrical machine 17. Additional drive energy for the compressor 6 can be provided via this electrical machine 17. If an excess of power should result in the turbine 16 in certain operating states, the turbine 16 can drive not only the compressor 6, but also drives the electrical machine 17 as a generator in this case. The electrical power then generated by the electrical machine 17 can be used or stored in the fuel cell system 1 in another manner. This construction of a so-called electric turbocharger is also known per se in the state of the art with fuel cell systems.

A particular advantage now results in that the exhaust heat present in the used air can now be used via the turbine 16. The heating with the catalytic reaction of exhaust gas from the anode region with oxygen in the intake air flow, which has been considered as very problematic up to now, can be used in a beneficial manner with this construction, as the heat transferred to the used air can now be used in the turbine 16 and be converted to mechanical energy. The construction of the fuel cell system according to FIG. 2 thus permits a beneficial use thereof by the active use of the exhaust heat resulting in the region of the catalytic material 13. Thereby, the amount of residual hydrogen due to thermal reasons or ageing reasons or system-technical reasons is no longer restricted, as in the state of the art. It is, in fact, sensible to convert as much hydrogen as possible in the fuel cell 2, but the construction of the fuel cell system according to FIG. 2 permits, however, the possibility to also convert larger amounts of residual hydrogen in the region of the catalytic material 13 in the exchanging device 12. This enables a foregoing of the anode recirculation. Also, a defined operation of the turbine 16 by means of the exhaust heat resulting in the region of the catalytic material 13 can now be carried out by the addition of fuel via the dosing device 14 and the guide element 15. Such a boost operation can be very sensible in certain operating situations. An example for such a situation could be that an increased power is abruptly demanded by the fuel cell 2, which results in a correspondingly increased power of the compressor 6. In such a case, a larger power could be provided at the turbine via an increase of the waste heat amount, which at least aids in covering the power demand of the compressor 6 in this situation. Alternatively, electrical energy can also be generated directly via the electrical machine 17 then operated in a generator manner by means of the addition of optional fuel and the boost of the turbine 16 carried out thereby. The additional electrical power can, for example, generate an abrupt power requirement in the electrical additionally and/or alternatively to the rather slowly reacting fuel cell 2.

The construction of the fuel cell system 1 according to FIG. 1 could additionally have a controllable or regulatable bypass, not shown here, around the exchanging device 12. The bypass could thereby be arranged on the intake air side and also on the used air side. It would permit passing a part of the material flow around the exchanging device 12, in order to mix this again with the original material flow in the case of the intake air or otherwise used air still required behind the exchanging device. A humidifying degree can thereby be adjusted in a very defined manner, or a humidification could be avoided in situations where it is not desired. As such, a bypass is, however, known in the state of the art with humidifiers, it shall not be discussed here in detail.

FIG. 2 shows an alternative embodiment of the fuel cell system 1. The same components are thereby provided with the same reference numerals and have a comparable functionality as the analogous components in FIG. 1. Thus, only the differences of the fuel cell system 1 according to FIG. 2 compared to the one described up to now are discussed in the following. The fuel cell system 1 of FIG. 2 has essentially only one difference compared to the fuel cell system 1 of FIG. 1. The difference is that the exhaust gas from the anode region 4 is not guided in a cycle, but that this exhaust gas flows directly into the exchanging device 12 on the intake air side. The fuel cell 2 is thus not operated with an anode cycle in the exemplary embodiment of FIG. 2, but with an anode, which is only passed through by hydrogen, wherein a certain excess of hydrogen discharges again from the anode region 4 as exhaust gas. This construction, which is also known in the state of the art, is generally combined with a division of the anode region into different active partial regions, wherein the successive partial regions in the flow direction of the hydrogen have decreasing active surfaces, so that the remaining hydrogen flow can largely be converted, without having to provide an unused active surface. With the use of such a cascaded anode region 4, it is possible with the supply of the fuel cell 2 with pure hydrogen from the hydrogen storage device 7 to drive with a very low excess of hydrogen of only 3-5%. This excess of hydrogen is then discharged from the anode region 4 as exhaust gas and reaches the exchanging device 12 on the used air side and here into the region of the catalytic material 13 on the intake air side. A comparable conversion of the hydrogen now results as already described with the exemplary embodiment according to FIG. 1, with all options already mentioned there.

It shall finally be noted that the fuel cell system 1 according to the arrangement of FIG. 2 can also have further components, which are generally known and usual. A bypass around the exchanging device 12 shall be mentioned here again in an exemplary manner, which could be used in an analogous manner to the above-described construction. A water separator can additionally be provided in the region between the exchanging device 12 and the turbine 16 in the exhaust air flow, in order to prevent liquid droplets from reaching the region of the turbine 16 and possibly damaging components thereof. Otherwise, the two embodiments can of course be combined among each other by a simple exchange of parts of the described fuel cell systems. It would thus, for example, be conceivable to combine the construction with the turbine 16 with the construction of the recirculation line 9. It would also be conceivable to forego the turbine 16 in a fuel cell system 1 as represented by FIG. 2.

1-11. (canceled)

12. A fuel cell system, comprising:
at least one fuel cell having a cathode region and an anode region;
an exchanging device coupled to the fuel cell to provide an intake air flow to the cathode region of the at least one fuel cell and to receive a used air flow is discharged from the cathode region of the fuel cell, wherein, in the exchanging device, heat is transferred from the intake air flow to the used air flow and water vapor is simultaneously transferred from the used air flow to the intake air flow;
a compressor driveable, at least in a supporting manner by a turbine, wherein the compressor receives the used air downstream of the exchanging device; and
a catalytic material, arranged on the used air side in the exchanging device and upstream of the turbine, to which a fuel-containing gas is supplied, wherein an exhaust gas from the anode region is supplied to the used air side of the exchanging device.

13. The fuel cell system according to claim 12, wherein hydrogen is supplied to the exchanging device as fuel-containing gas.

14. The fuel cell system according to claim 12, wherein the catalytic material is a coating on the used air side of the exchanging device.

15. The fuel cell system according to claim 12, wherein the exchanging device has an at least partially a honeycomb structure.

16. The fuel cell system according to claim 12, wherein the exchanging device is flown through essentially in a counterflow, wherein the catalytic material is arranged in a region on the used air side where the used air flows from the exchanging device and where the intake air flows into the exchanging device.

17. The fuel cell system according to claim 12, wherein the anode region is arranged such that hydrogen or hydrogen-containing gas flows through the anode region, wherein an output of the anode region is connected to an input on the used air side of the exchanging device.

18. The fuel cell system according to claim 17, wherein the anode region includes several sections connected in series, each of the several sections having an active surface in the flow direction of the hydrogen or of the hydrogen-containing gas in the anode region that is respectively smaller than an active surface of a previous one of the several sections.

19. The fuel cell system according to claim 12, wherein hydrogen flows through the anode region, wherein an output of the anode region is connected to an input of the anode region via a recirculation line and a feed device, wherein the recirculation line is connected to an input of the exchanging device on the used air side via a switchable valve device.

20. The fuel cell system according to claim 16, wherein a region with the catalytic material is thermally shielded with regard to an intake air side of the exchanging device.

21. The fuel cell system according to claim 12, wherein the compressor is coupled an electrical machine that drives the compressor, wherein the turbine drives the electrical machine in a generator manner to generate electrical power with a power excess at the turbine.

22. A method of using a fuel cell system comprising at least one fuel cell having a cathode region and an anode region, an exchanging device coupled to the fuel cell, a compressor coupled to the exchange device and a turbine and a catalytic material arranged on a user air side of the exchanging device, the method comprising:
providing, by the exchanging device to the fuel cell, an intake air flow to the cathode region of the at least one fuel cell;
receiving, by the exchanging device from the fuel cell, a used air flow discharged from the cathode region of the fuel cell, wherein, in the exchanging device, heat is transferred from the intake air flow to the used air flow and water vapor is simultaneously transferred from the used air flow to the intake air flow;
driving the compressor, at least in a supporting manner, by the turbine, wherein the compressor receives the used air downstream of the exchanging device;
supplying, to the catalytic material a fuel-containing gas; and
supplying an exhaust gas from the anode region to the used air side of the exchanging device.
